(19) United States
(12) Patent Application Publication
(10) Pub. No.: US 2010/0018547 A1
(43) Pub. Date: Jan. 28, 2010

(54) ORAL HYGIENE DEVICE

(75) Inventor: Peter Anthony Roemuss, Queensland (AU)

Correspondence Address: Peter Anthony Roemuss, 33 Forestwood Court, Nerang, Gold Coast, 4211, AU

(73) Assignee: FLOSSPIK PTV LTD, Gold Coast (AU)

(21) Appl. No.: 12/527,192

(22) PCT Filed: Feb. 14, 2008
(86) PCT No.: PCT/AU2008/000180

§ 371 Date: Aug. 14, 2009

(30) Foreign Application Priority Data
Feb. 14, 2007 (AU) 2007900708
Oct. 5, 2007 (AU) 2007905473

(51) Int. Cl. A61C 15/02; A61C 15/04

(52) U.S. Cl. 132/323

(57) ABSTRACT

An oral hygiene device (10) comprising first and second parts (46,47), the first part (46) comprising a hollow body portion which encloses dental floss (64) and the other part (47) defining a toothpick, the dental floss(64) being attached to the first and second parts (46,47), the first part (47) being separable from the second part (46) so that the parts (46, 47) can act as handles between which the dental floss (64) can be tensioned. The part (46) may have ribs (54) on at least one face for enhancing gripping and also to enable the device (10) to be used as a tongue cleaner or scraper. The first part (46) may also carry a capsule (60 which can contain a liquid such as a mouth wash or breath freshener or a solid substance such as a lozenge.

### TECHNICAL FIELD

This invention relates to an oral hygiene device and in particular to an oral hygiene device for use in cleaning the teeth or spaces between the teeth. The present invention also relates in another aspect to an oral hygiene device for use in cleaning of the tongue.

### BACKGROUND ART

Toothbrushes both manual toothbrushes and powered toothbrushes are commonly used in conjunction with toothpaste to clean the teeth. Toothbrushes however are not always fully effective in reaching the space between the teeth where food particles tend to gather and thus in addition to the use of toothbrushes, teeth are often cleaned with dental floss or dental tape which is used by being held taunt and manipulated between the teeth to remove food which is trapped between the teeth. For this purpose, dental floss or tape is usually provided in a dispenser and a length of floss or tape is withdrawn from the dispenser and severed therefrom and then gripped by two hands so that tension can be applied to the floss or tape for use. Tensioning of the floss or tape, can prove difficult particular where the floss or tape is wax coated as gripping of the tape becomes difficult. As a result, persons wishing to clean their teeth with floss or tape often find the task difficult.

Toothpicks are also used for removing food between the teeth and these usually are more easy to use in certain circumstances. Toothpicks however usually do not have the same effectiveness as floss or tape.

### SUMMARY OF THE INVENTION

The present invention aims to provide an oral hygiene device which overcomes or alleviates the above disadvantages or which at least provides a useful alternative to the know oral hygiene devices. The present invention in particular aspect aims to provide an oral hygiene device which incorporates both a dental floss or tape and a toothpick and which facilitates the use of the dental floss or tape and/or the toothpick. The present invention in another aspect aims to provide an oral hygiene device which may be used for cleaning of the tongue. Other objects and advantages of the invention will become apparent from the following description.

The present invention thus provides in one aspect, an oral hygiene device comprising first and second interconnected parts, at least one of said parts defining a toothpick, at least the other of said parts including an enlarged body portion having an internal hollow space, said enlarged body portion defining a grip for said device, dental floss within said space, said dental floss being anchored to said first and second parts of said device respectively said parts of said device being adapted to be separated to release said dental floss from said hollow space to enable said floss to be tensioned between said separated parts of said device when said parts are moved away from each whereby said tensioned floss may be used for cleaning of the teeth.

The first and second parts can thus be gripped and act as handles for gripping by the respective hands of a user and moved apart to tension the floss for use.

One of the parts is suitably adapted to cooperate with the other of the parts to close the hollow space containing the dental floss and capture the floss therein such that when the parts are separated, access to the hollow space and the dental floss therein is possible.

The enlarged body portion may have an external grip enhancing surface to enhance gripping thereof. The grip enhancing surface may comprise a roughened or ribbed surface. The enlarged body portion may comprise in one embodiment a tongue scraper or cleaner. In one form, the ribs provided on the surface of the body portion define the tongue scraper or cleaner.

Preferably the first and second parts are adapted to be releasably secured together. Preferably the parts are releasably secured together at a junction or along a junction line at which the parts may be separated. The parts may be secured together by adhesives, by welding or by at least being partially integrally joined. The parts may be separated by rupturing the device along the junction line. The junction line may comprise a line of weakness to facilitate rupturing of the device. The line of weakness may be defined by a reduced thickness region of the device.

In an alternative configuration, the body parts are adapted to be interconnected by cooperable fastening means such as male/female fastening means. The body parts may then be released and separated by disconnecting the fastening means to provide access to the hollow chamber part and dental floss therein.

In one preferred embodiment the first part comprises the toothpick defined by a tapering member and the second part defines the enlarged body portion, the first part being joined to the second part at the junction or along a junction line.

In another preferred embodiment each of the first and second parts are substantially identical and include an elongated tapering member defining the toothpick with the enlarged body portions joined end to end at the junction line or line or weakness The hollow spaces within the enlarged body portions which join each other at the junction line suitably cooperate to define an enlarged hollow chamber in which the dental floss is held. The elongated tapering members suitably define toothpicks extending to opposite sides of the enlarged chamber.

The tapering members suitably taper to a point to define the toothpick. The or each tapering member suitably extends away from the enlarged body portion and may be integrally formed therewith.

An enlarged body portion may be defined by a hollow base member fixed to or integral with the elongated member defining the toothpick and a cover adapted to cooperate with the base member to define the hollow space within the body portion The cover may be releasably engaged with the base member so as to provide access for installation of the floss with the hollow space in the body portion. The cover is suitably complementary to the base member and complementary coupling means may be provided therebetween. The complementary coupling means may comprise a socket on one member and a complementary peg or pin on the other member.

At least the cover may have a grip enhancing surface to enhance gripping thereof. The base member alternatively or additionally may also have a grip enhancing surface. The grip enhancing surface may comprise a roughened or ribbed surface. Preferably the floss is anchored or secured at one end to the base member of the enlarged body portion. The floss may be clamped between the cover and base member when the cover is engaged with the base member. The floss may be clamped between the peg or pin and the socket. The cover and/or base member may also comprise a tongue scraper or cleaner.

Where the first part comprises the toothpick and the second part comprises the enlarged body portion, the tapering member defining the toothpick may be formed integrally with the base member of the enlarged body portion and be breakable or severable therefrom at the junction or along the line of weakness between the tapering member and base member.

Where the first and second parts are substantially identical and each includes an elongated tapering member defining the toothpick and an enlarged body portion, each enlarged body portion is suitably defined by a hollow base member and cover. The respective base members may be joined along the junction line which is positioned centrally between opposite ends of the device, the junction line defining a line of weakness. In this configuration, a common cover may cooperate with each base member to closed the base members and define the enlarged hollow chamber. The base members and associated tapering members may be integrally formed. Transverse lines of weakness may be provided along the junction line in both the common cover and between the respective base members, the lines of weakness being aligned when the cover is placed onto the base members.

In yet another arrangement, the device may be moulded in two longitudinal halves which are joined along a longitudinally split line such as by adhesives or welding.

The dental floss may be of any form and thus the term “denial floss” as used throughout the specification and claims includes a thread, tape or any other form of filamentary element.

Preferably, the enlarged body portion is provided with an auxiliary chamber for directly or indirectly holding a liquid such as a mouth wash or freshener or a solid substance or material such as a lozenge, tablet or the like which may be used for breathe freshening purposes or any other purpose. The auxiliary chamber may be closed by a sealing cap or the like. The sealing cap may be detachable from the auxiliary chamber or hingedly mounted to the body portion to close or open the auxiliary chamber.

The auxiliary chamber may be adapted to carry a capsule or container for holding the liquid or solid material. The capsule or container is suitably detachable from the enlarged body portion and may be piercable to release the liquid when held in the capsule.

The oral hygiene device is suitably moulded of plastics with the components therefore formed in an injection moulding process.

It will be appreciated that the oral hygiene devices provide a toothpick facility and dental floss facility for cleaning the teeth. As the dental floss is located in a closed chamber within the devices, it cannot be contaminated.

### BRIEF DESCRIPTION OF THE DRAWINGS

Reference will now be made to the accompanying drawings which illustrate preferred embodiments of the invention and wherein:

FIG. 1 is a plan view of an oral hygiene device according to a first embodiment of the invention;

FIG. 2 is an enlarged view of the region A of FIG. 1;

FIG. 3 is a longitudinal sectional view of the device of FIG. 1 showing the dental floss or tape of the device contained within a hollow chamber of the device;

FIG. 4 illustrates the oral hygiene device of FIG. 1 with the two end parts of the device separated for use;

FIG. 5 is an exploded view of one end part of an alternative oral hygiene device according to another aspect of the invention;

FIG. 6 is a longitudinal sectional view of an oral hygiene device including end parts of the type shown in FIG. 5;

FIGS. 7 and 8 illustrate in exploded views from opposite sides an alternative construction of an oral hygiene device of the type shown in FIG. 1;

FIG. 9 is a perspective view of an oral hygiene device according to a second embodiment of the invention;

FIGS. 10 and 11 are side and top views of the device of FIG. 9;

FIG. 12 illustrates the device of FIGS. 9 to 11 with the top cover removed;

FIG. 13 is an exploded view of the device of FIG. 9 with the top cover removed showing the dental floss or tape containing chamber;

FIG. 14 illustrates the manner in which the toothpick of the device is separated from the remainder of the device;

FIG. 15 illustrates the oral hygiene device of FIG. 9 with the toothpick separated from the remainder of the device with the tooth floss or tape therebetween; and

FIG. 16 is a view similar to FIG. 15 with the capsule detached.

### DETAILED DESCRIPTION OF THE PREFERRED EMBODIMENT

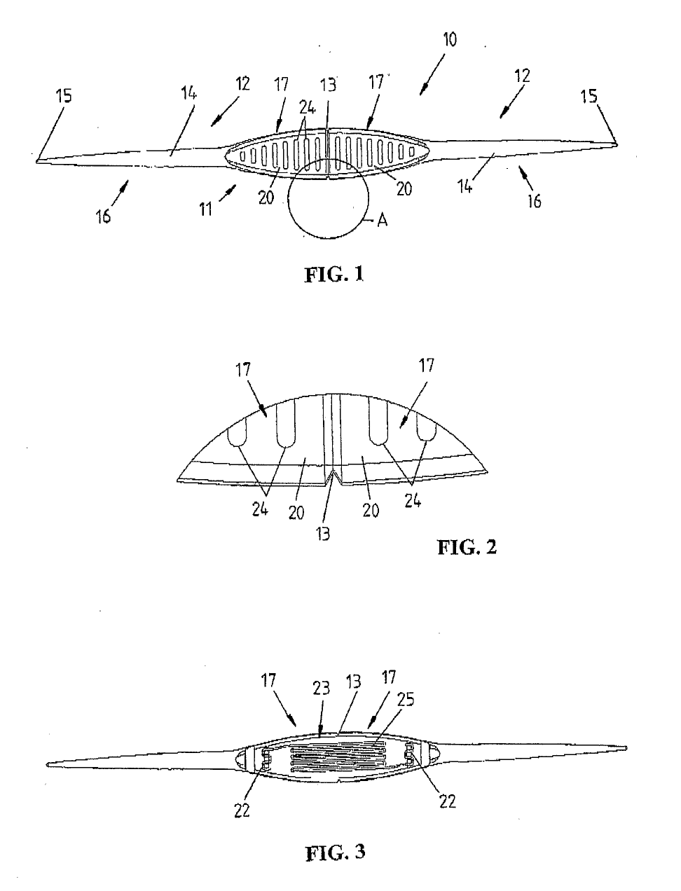

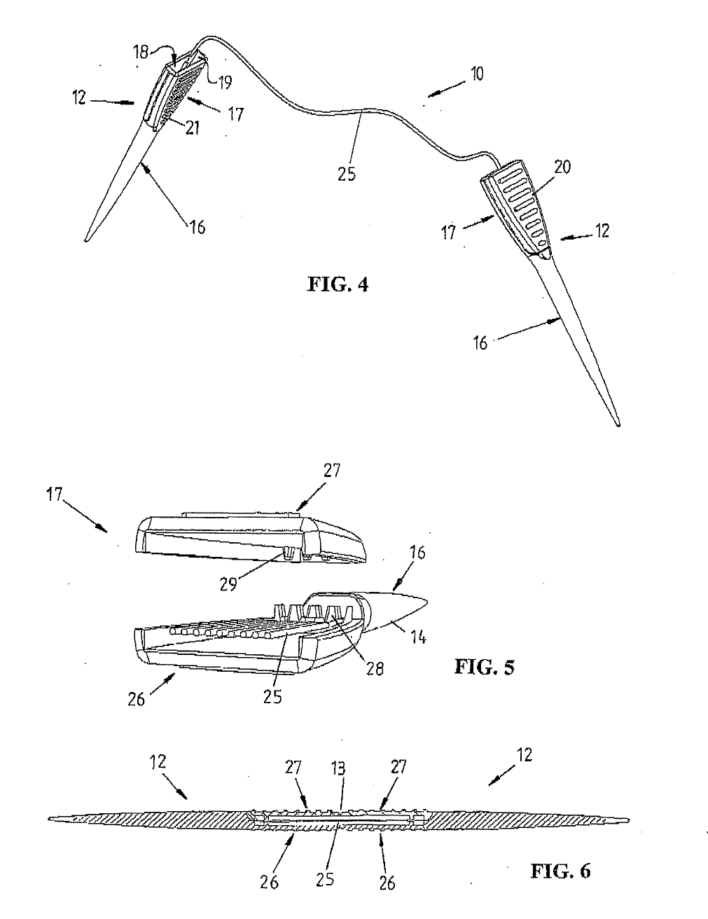

Referring to the drawings and firstly to FIGS. 1 to 3, there is illustrated an oral or dental hygiene device 10 according to an embodiment of the invention which includes an elongated body 11 comprising a pair of substantially identical opposite end parts 12 which are longitudinally aligned with each other and which are releasably joined at junction 13 but which can be separated at that junction 13. Each end part 12 comprises a thin elongated member 14 at one end which tapers to a point 15 to define a toothpick 16. The elongated member 14 is typically solid but may be hollow and may be of any cross section but preferably is of circular cross section. Each end part 12 additionally includes at its end opposite the elongated member 14, an enlarged hollow body part 17 which defines internally a hollow space 18 which opens at 19 to the free end of the body part 12. The hollow body part 17 diverges in width away from the member 14 and is of a substantially rectangular cross section which tapers in width from the open end 19 of the space 18 towards the elongated toothpick member 14. The hollow body part 17 additionally includes opposite major side faces or side walls 20 and 21 (see FIG. 4).

Located within the hollow space 18 of the hollow body part 17 and towards the junction of the body part 17 with the toothpick defining member 14 are anchoring posts or points 22 for a purpose which will become apparent below. When the end parts 12 of the body 11 are longitudinally aligned and joined at the junction 13 as in FIGS. 1 and 3, the opposing hollow spaces 18 combine to define a hollow chamber 23 which spans each end part 12. The opposite side faces or walls 20 mid 21 of the body part 17 are generally planar to enable the body part 17 to be readily gripped between the thumb and finger of a hand. At least one of the side faces or walls 20 and/or 21 is provided with a plurality of spaced upstanding gripping ribs 24 which extend transversely of the body part 17 to facilitate non-slip gripping between the thumb and finger of the hand, The ribs 24 on at least one of the side faces or walls 20 or 21 also serve in use as a tongue scraper for cleaning of the tongue. The ribs 24 for this purpose may taper in width to terminate in a transverse outermost edge. Thus the ribs 24 may be of a triangular cross section with the base of the triangle being on the side wall or face 20 or 21.

Located within the chamber 23 is a length of dental floss 25 such as thread or tape which is anchored at opposite ends to the respective anchoring posts or points 22, The floss 25 may be anchored to the posts or points 22 by any anchoring arrangement for example by being tied off to the posts 22, by a clamping arrangement, by welding such as by sonic or thermal welding or by adhesives. The floss 25 as shown in FIG. 3 is folded back on itself a number of times whilst the opposite ends thereof are anchored to the posts 22. Typically the floss 25 may be of a length of eight to twelve centremetres but may be of an increased or reduced length.

The opposite end parts 12 may be joined by positioning the body parts 17 in an end-to-end relationship and joining them by adhesives, by welding or by any other releasable connection arrangement. The junction 13 between the two body parts 17 forms a line of weakness extending around the device 10 with the line or weakness also defining a reference mark apparent to a person wishing to use the device 10. The open ends 19 of the body parts 17 by joining of the body parts 17 as above are also closed so that the dental floss 25 is fully contained within the formed chamber 23

In use, the device IO may be used for cleaning the interstitial spaces between the teeth of a person by use of the toothpicks 16 at opposite ends of the device 10 in a conventional manner to free material or foodstuffs from between the teeth. Where however a user wishes to use dental floss for cleaning between the teeth, the user grasps the respective end parts 12 of the device 10 usually with the two hands gripping the respective parts 17 after which the two end parts 12 can be separated at the junction 13. This may be achieved by bending the two end parts 12 relative to each other about the junction 13 to rupture the connection between the end parts 12, this being facilitated by the line of weakness extending around the device 10. The separated end parts 12 now define two handles as shown in FIG. 4 with the dental floss 25 released from the chamber 23 remaining anchored to the respective separated parts 12 and extending therebetween. The user by moving the end parts 12 away from each other can tension the dental floss and use the tensioned floss or tape for cleaning the teeth. So that sufficient tension can be applied to the floss 25, the user positions the thumb and finger of each hand over the opposite side faces or walls 20 and 21 to firmly grip the body parts 12. The toothpick 16 of each end part 12 may also be used after the parts 12 have been separated as in FIG. 4 by tipping the parts 17 and manipulating the point 15 of a toothpick 16 as desired. Furthermore for cleaning of the tongue, the toothpick defining member 14 can act as a handle to be gripped in the hand and a side face or wall 20 or 21 carrying ribs 24 applied to the tongue and scraped or wiped over the tongue. After use the device 10 may be simply discarded.

The two end parts 12 rather than being joined by adhesives or welding may be joined by a releasable connectors for example pins and cooperable apertures in the ends of the respective end parts 12 with the pins being inserted into the apertures as a frictional fit to hold the two parts 12 in alignment as in FIG. 1 and 3. Any other male/female type connection however may be provided between the parts 12. The joined parts 12 may then be separate either by breaking the connection at the junction 13 or moving the two parts 12 longitudinally away from each other to release the connection. The parts 12 in the latter instance may be reconnected if desired using the connectors.

The parts 12 are formed by moulding of plastics and are preferably identical such that only one mould cavity is required to form the two parts 12. As an alternative to the anchor posts or points 22 for the floss 25, the body parts 17 may be provided with apertures through which an end of the floss 25 may pass to be secured externally of the body part 17.

Referring now to FIGS. 5 and 6, there is illustrated a preferred method of construction of the oral hygiene device 10 according to the first embodiment of the invention. Each end part 12 of the device 10 is of the construction of FIG. 5 and comprises the tapering toothpick defining member 14 which extends from the enlarged body part 17 which ill this case is defined by a first hollow base part 26 fixed to the toothpick defining member 14 and a second cover part 27 adapted to cooperate with the base part 26 to define a hollow space which contains the dental floss 25. The cover part 27 and base part 26 may be attached to each other by screw fasteners or the like or alternatively the cover part 27 and base part 26 may be provided with complementary male/female connectors which enable the parts 26 and 27 to be frictionally interconnected Each part 26 and 27 includes opposed clamping posts 28 and 29 which can cooperate when the parts 26 and 27 are brought together to clamp an end of the dental floss 32 therebetween. The end parts 12 as described above are joined in longitudinal and end-to-end alignment to form the junction 13 as in FIG. 6. Access to the base parts 26 is available prior to installation of the cover parts 27 to allow placement of the dental floss 25 in position. The end parts 12 may then be separated by rupturing the device at the junction 13 between the end parts 12 and the device 10 used as described above.

The device 10 may be manufactured with tie end parts 12 formed separately and subsequently joined. Alternatively base parts 26 with toothpick defining members 14 may be formed integrally with the cover parts 27 formed separately for engagement with the respective base parts 26 after installation of the dental floss 25.

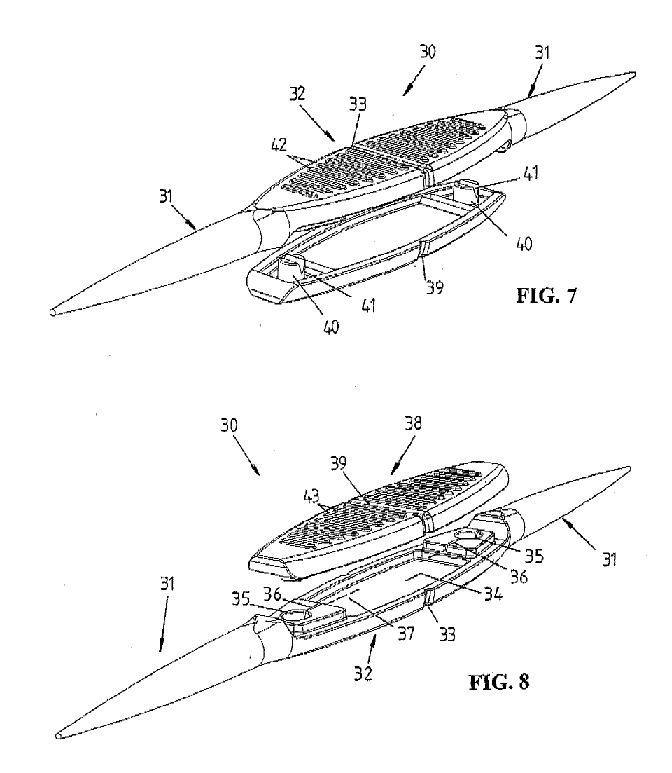

FIGS. 7 and 8 illustrate an alternative construction of oral hygiene device 30 according to the invention comprising in this case a main elongated body provided with elongated toothpick defining parts 31 at each end and an integrally formed central hollow enlarged base part 32 similar to a pair of base parts 26 arranged in end to end relationship. A line of weakness 33 defined by a V-sectioned groove extends transversely of the base part 32 and is positioned centrally relative to opposite ends of the device. The base part 32 is provided internally with a shallow recess 34 and with a pair of sockets 35 at each end of the recess. Grooves 36 extend from opposite ends of the recess 34 into the respective sockets 35 for receiving opposite ends of dental floss 37 shown in dotted outline.

The device 30 additional includes a cover part 38 complementary to the base part 32, the cover part 38 also being provided with a central transverse line of weakness 39 in the form of a V-shaped groove which reduces the thickness of the wall of the cover part 38. The cover part 38 additionally includes on its underside a pair of outwardly extending posts 40 which are spaced apart the same distance as the sockets 35 and which are complementary to the sockets 35. The posts 40 additionally are provided on their lower face with V-shaped grooves 41. Both the base part 32 and cover part 38 are provided in their outer surfaces with a series of transversely extending ribs 42 and 43 respectively similar to the ribs 24 of the embodiment of FIG. 1.

For assembly purposes, the dental floss 37 is positioned in the recess 34 of the base part 32 in a similar orientation to that shown in FIG. 3 being folded back on itself with the ends of the floss 37 passed into the grooves 36 and into the sockets 35. The cover part 38 is then mounted to the base part 32 by urging the posts 40 into the sockets 35 with an adhesive applied to mating surfaces or edges including surfaces and edges around the periphery of the respective parts and to the posts 40 and/or sockets 35 to join the parts 32 and 38. Alternatively the parts may be joined by sonic welding. The opposite ends of the floss 37 are thus clamped in position between the posts 40 and sockets 35 which is facilitated by the grooves 41 and thereby secured at opposite ends. In addition, the line of weakness 33 in the base part 32 is aligned with the line of weakness 39 in the cover part 38. In an alternatively method of connecting the dental floss, the floss 37 may be held in position by a weld bead or beads on the cover part 38 which when subject to heat melts into the grooves 36 to trap the floss 37 therein,

The device of FIGS. 7 and 8 is then used in the same manner as described above with the members 31 being available for use as toothpicks whilst the breaking of the device along the aligned transverse lines of weakness 33 and 39 will separate the device into two handle-like members in the manner shown in FIG. 4 to enable the floss 37 to be tensioned. Each separated part may also be used as a tongue cleaner by applying the ribs 42 or 43 on the outer sides of the base part 32 and cover 38 to the tongue and scraping along the tongue.

The embodiments described with reference to FIGS. 1 to 8 may be varied in design without departing from the broad aspect of the invention. For example, one of the body parts 12 of the device 10 of FIG. 1 may include a toothpick 16 with the other part 12 excluding a toothpick 16 but acting as an end closure of the hollow space 18.

In another method of manufacture, the device 10 of FIG. 1 may be moulded such as by injection moulding in two longitudinally split parts each defining half of the central chamber 23 and opposite halves of both toothpicks 16. After installation of the dental floss 25, the two parts may be joined along a longitudinal split line by welding or adhesives to form the assembled device. In this embodiment the line of weakness 13 around the chamber 28 is formed in the moulding process.

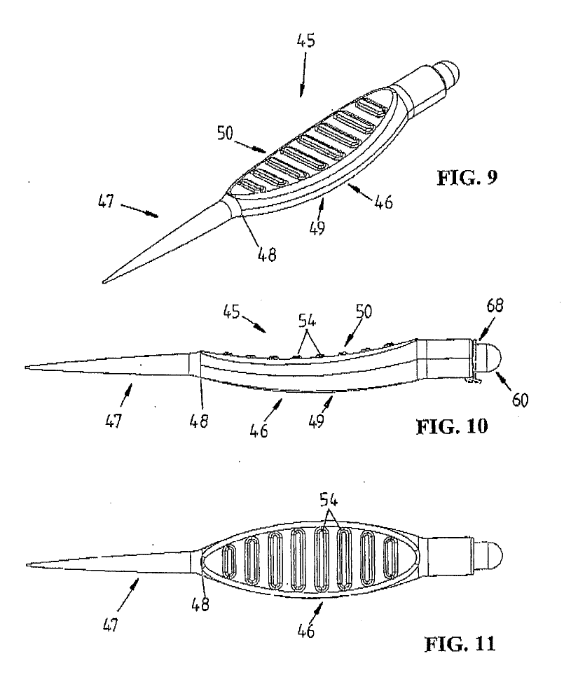

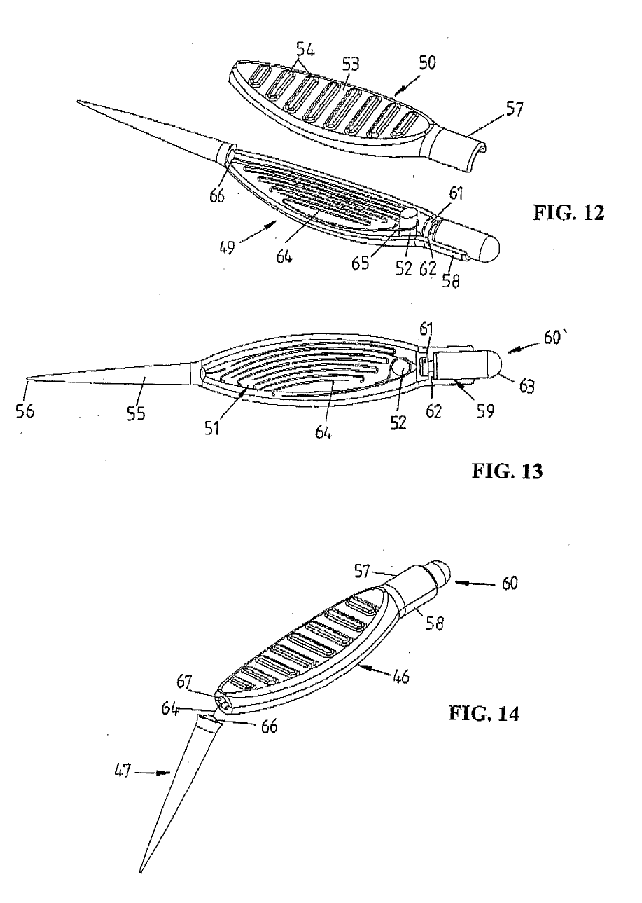

Referring now to FIGS. 9 to 11, there is illustrated an oral or dental hygiene device 45 according to a second embodiment of the invention which includes a main body part 46 and a detachable end part 47 which can be separated from the main body part 46 at the junction 48 between the parts 46 and 47. The main body part 46 includes as shown more clearly in FIG. 12, 4 base 49 and a complementary top cover 50 which is adapted for engagement with the base 49 to define a hollow chamber 51 within the main body part 46. Located within the base 49 at the end thereof opposite the end part 47 is an upstanding anchoring post or point 52 for a purpose which will become apparent below. When the base 49 and cover 50 are aligned and joined, they define the hollow chamber 51. The cover 50 has a top surface 53 of a slightly concave configuration and is provided with a plurality of transverse fibs 54 to facilitate gripping by hand. The ribs 54 may also be configured to act as a tongue cleaner as referred to above,

The base 49 of the main body part 46 is also formed at one end integrally with the detachable end part 47 which as illustrated comprises a thin elongated member 55 which tapers to a point 56 to define a toothpick (see FIG. 13). The elongated member 55 is typically solid but may be hollow and may be of any cross section but preferably is of circular cross section. The base 49 and cover 50 are also provided at their ends opposite the detachable end part 47 with half-tubular members 57 and 58 which cooperate when the cover 50 is placed on the base 49 to define an auxiliary housing or chamber 59 of hollow tubular form. A capsule 60 of complementary cross section to the housing 59 is receivable in the housing 59 and may have an end necked portion terminating in an enlarged head 61 at its inner end to be captured behind opposing walls 62 of the base part 49 and cover part 50. The capsule 60 has a detachable or piercable end cap 63 to allow access to the interior thereof. The capsule 60 may contain a lozenge or other substance such as a breath freshener or the like or alternatively may contain a liquid such as a mouthwash or mouth or breath freshener.

Located within the chamber 51 is a length of dental floss 64 such as thread or tape which is looped at one end 65 for location about and anchoring to the post 52. The floss 64 alternatively may be anchored to the post or point 52 by any anchoring arrangement for example by being tied off to the post 52, by a clamping arrangement, by welding or by adhesives. The floss 64 as shown in FIGS. 12 and 13 is folded back on itself a number of times and typically may be of a length of eight to twelve centre metres but may be of an increased or reduced length.

The opposite end of the floss 64 is secured at 66 to the inner end of the end part 47 of the device 45 which defines the toothpick by adhesives, welding or any other connection arrangement.

The base 49 and cover 50 may be brought together after installation of the dental floss 64 and joined by adhesives, by welding or by any other connection arrangement. The junction 48 between the end part 47 and base 49 of the body part 46 comprises a line of weakness for detachment of the end part 47 as described below.

In use, the device 45 may be used as a toothpick with the end part 47 defining the toothpick used in a conventional manner to free material or foodstuffs from between the teeth by gripping of the main body part 46 which is facilitated by the friction reducing ribs 54. Where however a user wishes to use dental floss, the user grasps the body part 46 and end part 47 and separates the end part 47 at the junction 48 as shown in FIG. 14. This may be achieved by bending the two parts 46 and 47 relative to each other about the junction 48 to rupture the connection between the end part 47 and base 49 of the main body part 46.

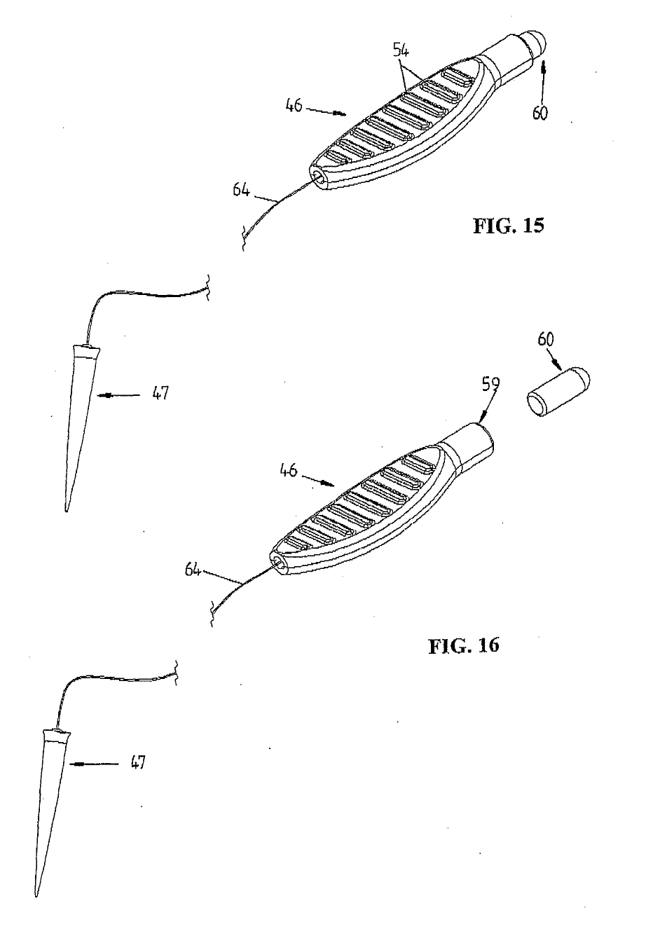

The end part 47 by breaking from the main body part 46 at the junction 48 forms an opening 67 into the chamber 51 through which the dental floss 64 may pass whilst the inner end thereof remains anchored to the base 49 of the main body part 46. The user by moving the end part 47 away from the main body part 46 a shown in FIG. 15 can draw the dental floss 64 from the chamber 51 and tension the dental floss 64 with the parts 46 and 47 acting as gripping handles for this purpose and thereafter use the tensioned floss or tape 64 for cleaning the teeth.

The end part 47 may also be used as a toothpick after the end part 47 has been separated from the body part 46. The end part 47 may also be used to pierce the capsule 60 to provide access to the contents thereof such as a liquid mouthwash. Alternatively the capsule 60 may be detached from its housing 59 as illustrated in FIG. 14 by breaking it away from the device at the necked portion to allow access to the contents thereof

For use as a tongue scraper, the device 45 is preferably used prior to detachment of the end part 47 which enables the end part 47 to serve as a gripping handle. The ribbed surface 53 of the cover 50 can then be applied to the tongue and scraped over the tongue for tongue cleaning.

As an alternative to having a capsule 60 which contains a liquid or a solid, the housing or chamber 59 defined by the opposing housing parts 57 and 58 may have the opposing walls 62 sealed to each other at the inner end of the chamber 59 with the outer end of the housing or chamber 59 closed by a cap 68 as shown in dotted outline in FIG. 10 sealingly engaged to the end of the housing of chamber 49. The cap 68 may be detachable from the end of the chamber 59 or hingedly mounted to the base 49 or cap 50 the enable the contents of the housing or chamber 49 to be accessed when desired. The auxiliary chamber 59 may be of many different configurations and may be formed in the base 49 or cap 50 alone and not defined between the base 49 and cap 50. The auxiliary chamber 59 may also be positioned other than at the end of the device 45.

The parts 46 and 47 are preferably formed by injection moulding of plastics. Alternatively, the device 45 may be manufactured with the parts formed separately and subsequently joined. As an alternative to the anchor post or point 52 for the floss 64, the base 49 may be provided with an aperture through which an end of he floss 64 may pass to be secured or the cover 50 and base part 49 may clamp and end of the floss 64 therebetween.

The ribs on the devices which provide a grip surface and further which define a tongue scraper may be of various configurations. For example the ribs may be curved in the longitudinal direction. The ribs may also have any cross sectional form.

The terms “comprising” or “comprises” and derivatives thereof as used throughout the specification are taken to specify the presence of the stated features, integers and components referred to but not preclude the presence or addition of one or more other feature/s, integer/s, component/s or group thereof.

Whilst the above has been given by way of illustrative embodiment of the invention all such variations and modifications thereto as would be apparent to persons skilled in the art are deemed to fall within the broad scope and ambit of the invention as defined in the appended claims.

1-20. (canceled)

21. An oral hygiene device comprising first and second interconnected parts, enlarged body portion comprising a base member and a cover defining therebetween an internal hollow space, said enlarged body portion having opposite major faces defined by said base member and cover respectively, said opposite major faces defining a hand grip for said device, dental floss within said hollow space, said dental floss being anchored to said first and second parts of said device respectively, said first and second parts of said device being at least partially integrally interconnected, a line or region of weakness at the interconnnection between said first and second parts, and said first and second parts being adapted to be separated from each other by rupturing said device at said line or region of weakness to release said dental floss from said hollow space to enable said floss to be tensioned between said separated parts of said device when said parts are moved away from each whereby said tensioned floss may be used for cleaning of the teeth.

22. An oral hygiene device as claimed in claim 21 wherein one of said parts is adapted to cooperate with the other of said parts to close an end of said hollow space containing said dental floss and capture the floss therein.

23. An oral hygiene device as claimed in claim 21 wherein at least one of said gripping thereof when said first and second parts are interconnected or separated.

24. An oral hygiene device as claimed in claim 23 wherein said grip enhancing surface comprises a roughened or ribbed surface.

25. An oral hygiene device as claimed in claim 23 wherein said at least one major face comprises a tongue scraper.

26. An oral hygiene device as claimed in claim 21 wherein said one of said parts comprises an elongated tapering member which tapers to a point to define said toothpick and the other of said parts comprises said enlarged body portion, said tapering member being substantially longitudinally aligned with said body portion and extending away therefrom.

27. An oral hygiene device as claimed in claim 26 wherein each of said first part and said second part includes a said enlarged body portion and an associated tapering member defining a toothpick, said tapering member being integrally formed with at least part of said body portion.

28. An oral hygiene device as claimed in claim 27 wherein said enlarged body portions are joined to each other such that said hollow spaces mate to define an enlarged hollow chamber containing said dental floss and wherein said elongated members extend to opposite sides of the enlarged chamber.

29. An oral hygiene device as claimed in claim 28 wherein each said body portion includes a said base member, said base members being interconnected and said line or region of weakness being formed between said base members.

30. An oral hygiene device as claimed in claim 29 wherein said cover comprises a common cover covering the base members of each said body portion.

31. An oral hygiene device as claimed in claim 30 wherein said cover is provided with a line or region of weakness aligned with said line or region of weakness between said body members.

32. An oral hygiene device as claimed in claim 21 wherein said first part comprises a tapering member defining said toothpick and wherein said second part comprises said enlarged body portion interconnected with said tapering member.

33. An oral hygiene device as claimed in claim 32 wherein said first part is integrally interconnected with said base member.

34. An oral hygiene device as claimed in claim 33 wherein said cover is adapted to cooperate with said base member to clamp one end of said dental floss therebetween.

35. An oral hygiene device as claimed in claim 32 wherein said cover and/or said base member define a tongue scraper.

36. An oral hygiene device as claimed in claim 35 wherein said major fare defined by said cover is concave and provided with a plurality of ribs to form said tongue scraper.

37. An oral hygiene device as claimed in claim 32 wherein said second part includes an auxiliary chamber for directly or indirectly holding a liquid or solid consumable substance or material.

38. An oral hygiene device as claimed in claim 37 wherein said auxiliary chamber is adapted to carry a capsule or container for holding said liquid, substance or material.

39. An oral hygiene device as claimed in claim 38 wherein said capsule or container is detachable from said second part to allow access to the contents of said capsule.

40. An oral hygiene device as claimed in claim 37 wherein said auxiliary chamber is defined between said cover and said base member.
